(19) United States
(12) Patent Application Publication
(10) Pub. No.: US 2025/0239699 A1
(43) Pub. Date: Jul. 24, 2025

(54) POWER STORAGE MODULE AND METHOD FOR MANUFACTURING THE SAME

(71) Applicant: TOYOTA JIDOSHA KABUSHIKI KAISHA, Toyota-shi Aichi-ken (JP)

(72) Inventor: Junta TAKASU, Nagoya-shi Aichi-ken (JP)

(73) Assignee: TOYOTA JIDOSHA KABUSHIKI KAISHA, Toyota-shi Aichi-ken (JP)

(21) Appl. No.: 19/018,005

(22) Filed: Jan. 13, 2025

(30) Foreign Application Priority Data
Jan. 19, 2024 (JP) 2024-006696

(51) Int. Cl. H01M 50/186; H01M 50/184; H01M 50/191; H01M 50/193; H01M 50/197

(52) U.S. Cl. CPC H01M 50/186; H01M 50/184; H01M 50/191; H01M 50/193; H01M 50/197

(57) ABSTRACT

In a power storage module, a sealing sheet covers end portions of current collector foils of a plurality of electrode plates in a first direction. The sealing sheet includes: a plurality of side wall portions; a plurality of folded portions; and a folded-back portion. The plurality of side wall portions are disposed on outer sides of the current collector foils of the plurality of electrode plates in the first direction, respectively. The plurality of folded portions are folded from the plurality of side wall portions toward spaces between the plurality of electrode plates, respectively. The folded-back portion connects corresponding two of the plurality of folded portions adjacent to each other between corresponding two of the plurality of electrode plates. Each of the plurality of folded portions is at least partially welded to the current collector foil of a corresponding one of the plurality of electrode plates.

### CROSS REFERENCE TO RELATED APPLICATIONS

This nonprovisional application is based on Japanese Patent Application No. 2024-006696 filed on Jan. 19, 2024 with the Japan Patent Office, the entire contents of which are hereby incorporated by reference.

### BACKGROUND

### Field

The present disclosure relates to a power storage module and a method for manufacturing the same.

### Description of the Background Art

Japanese Patent Laying-Open No. 2019-91606 discloses a power storage device including a plurality of bipolar batteries. Each of the bipolar batteries includes an electrode stack portion and a seal frame. The electrode stack portion is formed by stacking a plurality of bipolar electrodes with separators being interposed. Each of the bipolar electrodes has a nickel foil, a positive electrode and a negative electrode. The seal frame is disposed to surround the electrode stack portion. The seal frame has a plurality of primary seal portions and a secondary seal portion. The plurality of primary seal portions hold edge portions of the nickel foils, respectively. An internal space defined by the nickel foil, the positive electrode, the negative electrode, and the primary seal portion is provided between the nickel foils adjacent to each other in a stacking direction. The primary seal portion seals the internal space. The secondary seal portion surrounds the primary seal portions and further seals the internal spaces.

### SUMMARY

In a power storage device including a conventional power storage module, spaces between electrode plates are sealed by a plurality of seal members. Therefore, these seal members lead to an increase in the number of components in the power storage module, which leads to a complicated structure of the power storage module. In addition, since there is a limit to making each of the seal members smaller, the space efficiency may decrease, which makes it difficult to increase the energy density of the power storage module.

The present disclosure has been made in view of the above-described problem, and an object of the present disclosure is to make the number of components in a power storage module relatively small and make a structure of the power storage module simple, and to increase the possibility of providing a power storage module having high energy density.

A power storage module according to a first aspect of the present disclosure includes: a plurality of electrode plates; a plurality of separators; and a sealing sheet. Each of the plurality of electrode plates includes a current collector foil and at least one active material layer formed on the current collector foil. A plane direction of each of the plurality of electrode plates extends along a first direction. The plurality of electrode plates are arranged side by side in a second direction orthogonal to the first direction. Each of the plurality of separators is disposed between the active material layers of corresponding two of the plurality of electrode plates adjacent to each other. The sealing sheet covers end portions of the current collector foils of the plurality of electrode plates in the first direction. The sealing sheet includes: a plurality of side wall portions; a plurality of folded portions; and a folded-back portion. The plurality of side wall portions are disposed on outer sides of the current collector foils of the plurality of electrode plates in the first direction, respectively. The plurality of folded portions are folded from the plurality of side wall portions toward spaces between the plurality of electrode plates, respectively. The folded-back portion connects corresponding two of the plurality of folded portions adjacent to each other between corresponding two of the plurality of electrode plates. Each of the plurality of folded portions is at least partially welded to the current collector foil of a corresponding one of the plurality of electrode plates.

Thus, the sealing sheet can seal the spaces between the plurality of electrode plates and can function as an exterior member for the plurality of electrode plates. Therefore, the number of components in the power storage module can be reduced, which can lead to a simple structure of the power storage module. Furthermore, according to the above-described configuration, the relatively thin sealing sheet can seal the spaces between the current collector foils. Therefore, a volume ratio of the plurality of electrode plates in the power storage module can be increased and the energy density of the power storage module can be enhanced.

In the power storage module, the sealing sheet may include a resin layer and a metal layer. The metal layer may be provided on a surface of the resin layer opposite to a surface of the resin layer facing the plurality of electrode plates. Thus, water permeation in the power storage module can be suppressed without further providing another member different from the sealing sheet.

In the power storage module, the resin layer may include a polypropylene resin or a polyethylene resin. Thus, a water absorption rate of the resin layer can be lowered.

In the power storage module, a groove portion may be formed in the resin layer of the folded-back portion. Thus, the stress in the folded-back portion of the sealing sheet can be relieved.

In the power storage module, the sealing sheet may further include an outer resin layer. The outer resin layer may be provided on a surface of the metal layer opposite to a surface of the metal layer that is in contact with the resin layer. Thus, the outer side of the metal layer can be easily insulated.

In the power storage module, the outer resin layers of corresponding two of the plurality of folded portions may be at least partially welded to each other between corresponding two of the plurality of electrode plates. Thus, the shape of the sealing sheet can be maintained more firmly.

In the power storage module, each of the plurality of electrode plates may include a first active material layer formed on the current collector foil, and a second active material layer formed on the current collector foil. The first active material layer may be located on one side of the current collector foil in the second direction. The second active material layer may be located on the other side of the current collector foil in the second direction. One of the first active material layer and the second active material layer may be a negative electrode active material layer, and the other may be a positive electrode active material layer. Each of the plurality of separators may be disposed between the first active material layer and the second active material layer adjacent to each other.

Thus, each of the plurality of electrode plates serves as a bipolar electrode, and the power storage module serves as a bipolar battery. In the power storage module serving as a bipolar battery, the plurality of current collector foils have different potentials. In order to suppress the occurrence of a short circuit, it is important to suppress mutual contact between the plurality of current collector foils. According to the above-described power storage module, one sealing sheet forms the plurality of folded portions and the folded-back portion, which makes it possible to suppress contact between the current collector foils. Furthermore, as described above, the sealing sheet can also function as an exterior member. Therefore, when the power storage module is a bipolar battery, the number of components can be made extremely smaller than that in a conventional bipolar battery.

The power storage module may be a power storage module implemented by a bipolar-type battery.

In the power storage module implemented by a bipolar-type battery, the plurality of current collector foils have different potentials. In order to suppress the occurrence of a short circuit, it is important to suppress mutual contact between the plurality of current collector foils. According to the above-described power storage module, one sealing sheet forms the plurality of folded portions and the folded-back portion, which makes it possible to suppress contact between the current collector foils. Furthermore, as described above, the sealing sheet can also function as an exterior member. Therefore, the number of components can be made extremely smaller than that in a conventional bipolar-type battery.

A method for manufacturing a power storage module according to a second aspect of the present disclosure includes: disposing a separator on at least one active material layer located on one surface side of a first electrode plate, the first electrode plate including a current collector foil and the at least one active material layer formed on the current collector foil; folding a sealing sheet from the other surface side of the current collector foil of the first electrode plate such that the sealing sheet covers an end portion of the current collector foil of the first electrode plate and a part of the one surface of the current collector foil of the first electrode plate; welding the sealing sheet to the part of the one surface of the current collector foil of the first electrode plate; folding back the sealing sheet on the one surface side of the current collector foil of the first electrode plate; welding the folded-back sealing sheet to a part of the other surface of a current collector foil of a second electrode plate opposite to one surface of the current collector foil of the second electrode plate, the second electrode plate including the current collector foil and at least one active material layer formed on the current collector foil; folding the sealing sheet from the other surface side of the current collector foil of the second electrode plate such that the folded-back sealing sheet covers an end portion of the current collector foil of the second electrode plate and a part of the one surface of the current collector foil of the second electrode plate; and disposing the active material layer of the second electrode plate on the separator.

Thus, the sealing sheet can seal the space between the current collector foil of the first electrode plate and the current collector foil of the second electrode plate, and can function as an exterior member for the first electrode plate and the second electrode plate. Therefore, the number of components in the power storage module can be reduced, which can lead to a simple structure of the power storage module. Furthermore, according to the above-described configuration, the relatively thin sealing sheet can seal the space between the current collector foil of the first electrode plate and the current collector foil of the second electrode plate. Therefore, a volume ratio of the first electrode plate and the second electrode plate in the power storage module can be increased and the energy density of the power storage module can be enhanced.

In the method for manufacturing the power storage module, disposing the active material layer of the second electrode plate on the separator may be performed after welding the sealing sheet to the part of the one surface of the current collector foil of the first electrode plate and after welding the folded-back sealing sheet to the part of the other surface of the current collector foil of the second electrode plate.

Thus, the sealing sheet can be welded during the process of stacking the first electrode plate, the separator and the second electrode plate. This can result in reduction of the number of the steps for manufacturing the power storage module.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view schematically showing a power storage module according to a first embodiment of the present disclosure.

FIG. 2 is a cross-sectional view of a part of the power storage module of FIG. 1 when viewed in the direction of an arrow II-II.

FIG. 3 is a cross-sectional view showing a part of a power storage module according to a comparative example.

FIG. 4 is a flowchart showing a method for manufacturing the power storage module according to the first embodiment of the present disclosure.

FIG. 5 is a flowchart showing step S1 of the method for manufacturing the power storage module.

FIG. 6A is a schematic cross-sectional view schematically showing a flow of step S1.

FIG. 6B is a schematic cross-sectional view schematically showing another flow of step S1.

FIG. 6C is a schematic cross-sectional view schematically showing another flow of step S1.

FIG. 6D is a schematic cross-sectional view schematically showing another flow of step S1.

FIG. 6E is a schematic cross-sectional view schematically showing another flow of step S1.

FIG. 7 is a flowchart showing a part of step S2 of the method for manufacturing the power storage module.

FIG. 8A is a schematic cross-sectional view schematically showing a part of a flow of step S2.

FIG. 8B is a schematic cross-sectional view schematically showing another part of a flow of step S2.

FIG. 8C is a schematic cross-sectional view schematically showing another part of a flow of step S2.

FIG. 8D is a schematic cross-sectional view schematically showing another part of a flow of step S2.

FIG. 8E is a schematic cross-sectional view schematically showing another part of a flow of step S2.

FIG. 8F is a schematic cross-sectional view schematically showing another part of a flow of step S2.

FIG. 9A is a schematic cross-sectional view schematically showing another part of the flow of step S2.

FIG. 9B is a schematic cross-sectional view each schematically showing another part of the flow of step S2.

FIG. 9C is a schematic cross-sectional view each schematically showing another part of the flow of step S2.

FIG. 9D is a schematic cross-sectional view each schematically showing another part of the flow of step S2.

FIG. 9E is a schematic cross-sectional view each schematically showing another part of the flow of step S2.

FIG. 9F is a schematic cross-sectional view each schematically showing another part of the flow of step S2.

FIG. 10 is a flowchart showing step S3 of the method for manufacturing the power storage module.

FIG. 11A is a schematic cross-sectional view schematically showing a flow of step S3.

FIG. 11B is a schematic cross-sectional view schematically showing another flow of step S3.

FIG. 11C is a schematic cross-sectional view schematically showing another flow of step S3.

FIG. 11D is a schematic cross-sectional view schematically showing another flow of step S3.

FIG. 11E is a schematic cross-sectional view schematically showing another flow of step S3.

FIG. 12 is a cross-sectional view showing a part of a power storage module according to a second embodiment of the present disclosure.

FIG. 13 is a cross-sectional view showing a part of a power storage module according to a third embodiment of the present disclosure.

### DESCRIPTION OF THE EMBODIMENTS

Hereinafter, a power storage module according to each embodiment of the present disclosure will be described with reference to the drawings. In the following description of the embodiments, the same or corresponding portions in the drawings are denoted by the same reference characters, and description thereof will not be repeated.

### First Embodiment

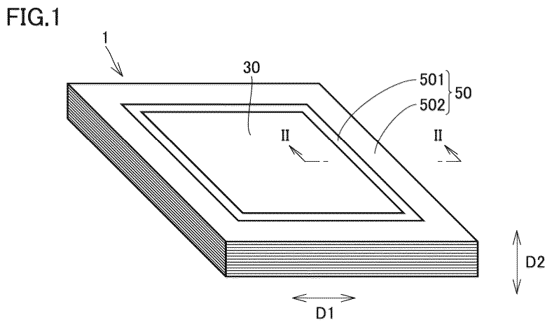

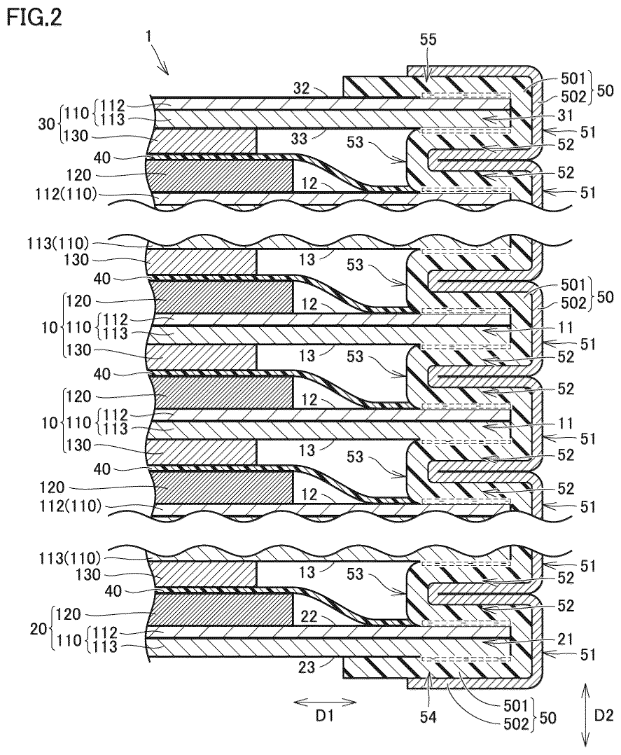

FIG. 1 is a perspective view schematically showing a power storage module according to a first embodiment of the present disclosure. FIG. 2 is a cross-sectional view of a part of the power storage module of FIG. 1 when viewed in the direction of an arrow II-II. As shown in FIGS. 1 and 2, a power storage module 1 according to the first embodiment of the present disclosure includes a plurality of electrode plates 10, a first terminal electrode 20, a second terminal electrode 30, a plurality of separators 40, and a sealing sheet 50.

Power storage module 1 may be a secondary battery such as a lithium ion battery. First terminal electrode 20, second terminal electrode 30 and sealing sheet 50 may be an exterior member for the secondary battery. One of first terminal electrode 20 and second terminal electrode 30 may be a positive electrode external terminal of the secondary battery, and the other may be a negative electrode external terminal. Power storage module 1 is provided to be capable of extracting a current from first terminal electrode 20 and second terminal electrode 30 to the outside.

A plane direction of each of the plurality of electrode plates 10 is along a first direction D1. The plurality of electrode plates 10 are arranged side by side in a second direction D2 orthogonal to first direction D1. Each of electrode plates 10 has, for example, a rectangular outer shape when viewed in second direction D2.

Each of electrode plates 10 has an end portion 11. End portion 11 is located at one end of electrode plate 10 in first direction D1. Electrode plate 10 has a first surface 12 and a second surface 13. First surface 12 is located on one side in second direction D2. Second surface 13 is located on the other side in second direction D2.

Each of electrode plates 10 is, for example, a bipolar electrode. Therefore, in the present embodiment, power storage module 1 is described as an example of a bipolar battery (bipolar-type battery). Electrode plate 10 includes a current collector foil 110, a first active material layer 120 and a second active material layer 130.

Current collector foil 110 extends along first direction D1. Current collector foil 110 forms end portion 11 of electrode plate 10. Current collector foil 110 forms a part of first surface 12 and a part of second surface 13 of electrode plate 10.

Current collector foil 110 includes a first current collector 112 and a second current collector 113. First current collector 112 and second current collector 113 are stacked in second direction D2. First current collector 112 forms a part of first surface 12 of electrode plate 10. Second current collector 113 forms a part of second surface 13 of electrode plate 10. First current collector 112 and second current collector 113 may include different metals. Current collector foil 110 may be configured by one member.

Current collector foil 110 (each of first current collector 112 and second current collector 113) may include at least one selected from the group consisting of aluminum (Al), stainless steel, nickel (Ni), chromium (Cr), platinum (Pt), niobium (Nb), iron (Fe), titanium (Ti), copper (Cu), and zinc (Zn), for example. Current collector foil 110 may be formed by plating a surface of a metal foil.

One of first current collector 112 and second current collector 113 may be a negative electrode current collector, and the other may be a positive electrode current collector. In the present embodiment, first current collector 112 is a negative electrode current collector and second current collector 113 is a positive electrode current collector. In some embodiments, the negative electrode current collector includes copper (Cu). In some embodiments, the positive electrode current collector includes aluminum (Al).

First active material layer 120 is located on one side of current collector foil 110 in second direction D2. First active material layer 120 is disposed on first current collector 112. First active material layer 120 forms another part of first surface 12 of electrode plate 10. First active material layer 120 is formed by applying a first active material to the one side in second direction D2. More specifically, first active material layer 120 is formed by applying the first active material onto first current collector 112.

Second active material layer 130 is located on the other side of current collector foil 110 in second direction D2. Second active material layer 130 is disposed on second current collector 113. Second active material layer 130 forms another part of second surface 13 of electrode plate 10. Second active material layer 130 is formed by applying a second active material to the other side in second direction D2. More specifically, second active material layer 130 is formed by applying the second active material onto second current collector 113.

One of first active material layer 120 and second active material layer 130 may be a negative electrode active material layer, and the other may be a positive electrode active material layer. One of the first active material and the second active material may be a negative electrode active material, and the other may be a negative electrode active material. In the present embodiment, first active material layer 120 is a negative electrode active material layer, the first active material is a negative electrode active material, second active material layer 130 is a positive electrode active material layer, and the second active material is a positive electrode active material.

Lithium, carbon, a metal compound, an element capable of being alloyed with lithium or a compound thereof, and the like can, for example, be used as the negative electrode active material.

Those capable of occluding and releasing electric charge carriers such as lithium ions can, for example, be used as the positive electrode active material. Specifically, those that can be used as a positive electrode active material of a lithium ion secondary battery, such as a lithium ion composite metal oxide having a laminar rock-salt structure, a metal oxide having a spinel structure, or a polyanion-based compound, can be used as the positive electrode active material. Alternatively, two or more types of positive electrode active materials may be used together, and the positive electrode active material may include, for example, olivine-type lithium iron phosphate (LiFePO₄).

First terminal electrode 20 has an end portion 21. End portion 21 is located at one end of first terminal electrode 20 in first direction D1. First terminal electrode 20 has a first surface 22 and a second surface 23. First surface 22 is located on one side in second direction D2. Second surface 23 is located on the other side in second direction D2.

First terminal electrode 20 includes current collector foil 110 and first active material layer 120. Except for the second surface 23 side, current collector foil 110 and first active material layer 120 of first terminal electrode 20 may have the same configurations as those of current collector foil 110 and first active material layer 120 of electrode plate 10. In the present embodiment, except for the second surface 23 side, current collector foil 110 and first active material layer 120 of first terminal electrode 20 have the same configurations as those of current collector foil 110 and first active material layer 120 of electrode plate 10.

In first terminal electrode 20, current collector foil 110 (second current collector 113) forms the whole of second surface 23 of first terminal electrode 20. First terminal electrode 20 is located on the outer side of the plurality of electrode plates 10 in second direction D2. The plurality of electrode plates 10 are located on the first surface 22 side of first terminal electrode 20.

Second terminal electrode 30 has an end portion 31. End portion 31 is located at one end of second terminal electrode 30 in first direction D1. Second terminal electrode 30 has a first surface 32 and a second surface 33. First surface 32 is located on one side in second direction D2. Second surface 33 is located on the other side in second direction D2.

Second terminal electrode 30 includes current collector foil 110 and second active material layer 130. Except for the first surface 32 side, current collector foil 110 and second active material layer 130 of second terminal electrode 30 may have the same configurations as those of current collector foil 110 and second active material layer 130 of electrode plate 10. In the present embodiment, except for the first surface 22 side, current collector foil 110 and second active material layer 130 of second terminal electrode 30 have the same configurations as those of current collector foil 110 and second active material layer 130 of electrode plate 10.

In second terminal electrode 30, current collector foil 110 (first current collector 112) forms the whole of first surface 32 of second terminal electrode 30. Second terminal electrode 30 is located on the outer side of the plurality of electrode plates 10 in second direction D2. The plurality of electrode plates 10 are located on the second surface 33 side of second terminal electrode 30.

One of first terminal electrode 20 and second terminal electrode 30 may be a negative terminal electrode, and the other may be a positive terminal electrode. In the present embodiment, first terminal electrode 20 is a negative terminal electrode, and second terminal electrode 30 is a positive terminal electrode.

The plurality of separators 40 are disposed between first terminal electrode 20 and electrode plate 10 adjacent to each other, between the plurality of electrode plates 10 adjacent to each other, and between electrode plate 10 and second terminal electrode 30 adjacent to each other, respectively. First terminal electrode 20, the plurality of electrode plates 10 and second terminal electrode 30 are stacked in second direction D2 with separators 40 being interposed.

Each of separators 40 is disposed between the active material layers adjacent to each other in second direction D2. More specifically, each of separators 40 is in contact with both of first active material layer 120 and second active material layer 130 adjacent to each other in second direction D2. Each of separators 40 may be welded to one of two current collector foils 110 adjacent to each other in second direction D2. Separator 40 located on the first surface 12 or 22 side when viewed from electrode plate 10 or first terminal electrode 20 is welded to current collector foil 110 of this electrode plate 10 or first terminal electrode 20. That is, separator 40 is welded to first current collector 112 adjacent thereto.

Separator 40 is formed to have a sheet shape. A porous film made of a polyolefin resin such as polyethylene (PE) or polypropylene (PP), woven or non-woven fabric made of polypropylene, methylcellulose or the like, or the like is given as an example of separator 40. Separator 40 may be reinforced with a vinylidene fluoride resin compound.

Sealing sheet 50 covers end portion 21 of first terminal electrode 20 in first direction D1, end portion 11 of each of the plurality of electrode plates 10 in first direction D1, and end portion 31 of second terminal electrode 30 in first direction D1. Sealing sheet 50 includes a plurality of side wall portions 51, a plurality of folded portions 52, a plurality of folded-back portions 53, a first edge portion 54, and a second edge portion 55.

The plurality of side wall portions 51 are disposed on the outer sides of first terminal electrode 20, the plurality of electrode plates 10 and second terminal electrode 30 in first direction D1, respectively. Side wall portion 51 faces end portion 21 of first terminal electrode 20 adjacent thereto in first direction D1, end portion 11 of each of the plurality of electrode plates 10 adjacent thereto in first direction D1, or end portion 31 of second terminal electrode 30 adjacent thereto in first direction D1. Specifically, side wall portions 51 are in contact with end portions 21, 11 and 31. Side wall portions 51 do not necessarily need to be in contact with end portions 21, 11 and 31.

The plurality of folded portions 52 are folded from the plurality of side wall portions 51 toward a space between first terminal electrode 20 and electrode plate 10, a space between the plurality of electrode plates 10 adjacent to each other, and a space between electrode plate 10 and second terminal electrode 30, respectively. Each of the plurality of folded portions 52 extends parallel to first direction D1.

A pair of folded portions 52 is located in each of the space between first terminal electrode 20 and electrode plate 10, the space between the plurality of electrode plates 10 adjacent to each other, and the space between electrode plate 10 and second terminal electrode 30. The pair of folded portions 52 are arranged side by side in second direction D2. The pair of folded portions 52 may be in contact with each other, or may be spaced apart from each other. In the present embodiment, the pair of folded portions 52 are in contact with each other.

Each of the plurality of folded portions 52 is welded to a corresponding one of the plurality of electrode plates 10. Specifically, folded portion 52 that faces first surface 12 or 22 of electrode plate 10 or first terminal electrode 20 is welded to first surface 12 or 22 of current collector foil 110 (first current collector 112), of first surface 12 or 22 of this electrode plate 10 or first terminal electrode 20. Folded portion 52 that faces second surface 13 or 23 of electrode plate 10 or second terminal electrode 30 is welded to second surface 13 or 23 of current collector foil 110 (second current collector 113), of second surface 13 or 23 of this electrode plate 10 or second terminal electrode 30.

Between first terminal electrode 20 and electrode plate 10, between the plurality of electrode plates 10 adjacent to each other, and between electrode plate 10 and second terminal electrode 30, the plurality of folded-back portions 53 connect the plurality of folded portions 52 adjacent to each other. That is, each of folded-back portions 53 connects the above-described pair of folded portions 52 to each other.

First edge portion 54 is located at one edge of sealing sheet 50. First edge portion 54 extends from side wall portion 51 located on the outer side of first terminal electrode 20 in first direction D1. First edge portion 54 extends parallel to first direction D1. First edge portion 54 faces second surface 23 of first terminal electrode 20 in second direction D2. First edge portion 54 is in contact with second surface 23 of first terminal electrode 20. First edge portion 54 is welded to second surface 23 of first terminal electrode 20. First edge portion 54 is in contact with second current collector 113 of first terminal electrode 20. First edge portion 54 is welded to second current collector 113 of first terminal electrode 20.

Second edge portion 55 is located at an edge of sealing sheet 50 opposite to first edge portion 54. Second edge portion 55 extends from side wall portion 51 located on the outer side of second terminal electrode 30 in first direction D1. Second edge portion 55 extends parallel to first direction D1. Second edge portion 55 faces first surface 32 of second terminal electrode 30 in second direction D2. Second edge portion 55 is in contact with first surface 32 of second terminal electrode 30. Second edge portion 55 is welded to first surface 32 of second terminal electrode 30. Second edge portion 55 is in contact with first current collector 112 of second terminal electrode 30. Second edge portion 55 is welded to first current collector 112 of second terminal electrode 30.

Sealing sheet 50 includes a resin layer 501 and a metal layer 502. Resin layer 501 is made of a resin composition including a thermally fusible resin. In the present embodiment, resin layer 501 includes a polypropylene resin such as polypropylene or modified polypropylene, or a polyethylene resin such as polyethylene or modified polyethylene.

Metal layer 502 is provided on a surface of resin layer 501 opposite to a surface of resin layer 501 facing first terminal electrode 20, the plurality of electrode plates 10 and second terminal electrode 30. A metal foil such as an Al foil, a Ni foil, a Cu foil, or a stainless foil can, for example, be used as metal layer 502. In the present embodiment, metal layer 502 is an Al foil.

A thickness of sealing sheet 50 is not particularly limited. In some embodiments, the thickness of sealing sheet 50 is equal to or less than 1 mm, for example. This makes formation of folded portions 52 and folded-back portions 53 easy. A total thickness of first terminal electrode 20, the plurality of electrode plates 10 and second terminal electrode 30 in power storage module 1 in second direction D2 is equal to or more than 15 mm and equal to or less than 20 mm, for example.

In power storage module 1 according to the present embodiment, an internal space defined by first terminal electrode 20, electrode plate 10 and sealing sheet 50, a plurality of internal spaces defined by the plurality of electrode plates 10 adjacent to each other and sealing sheet 50, and an internal space defined by electrode plate 10 and second terminal electrode 30 are formed. That is, sealing sheet 50 seals power storage module 1.

An electrolyte solution (not shown) may be injected into these internal spaces. An electrolyte solution does not necessarily need to be injected into these internal spaces. When power storage module 1 does not include an electrolyte solution, separators 40 may be a solid electrolyte.

A power storage module according to a comparative example will now be described. The power storage module according to the comparative example is a bipolar battery. Description of a configuration of the power storage module according to the comparative example that is the same as the configuration of the power storage module according to the first embodiment will not be repeated.

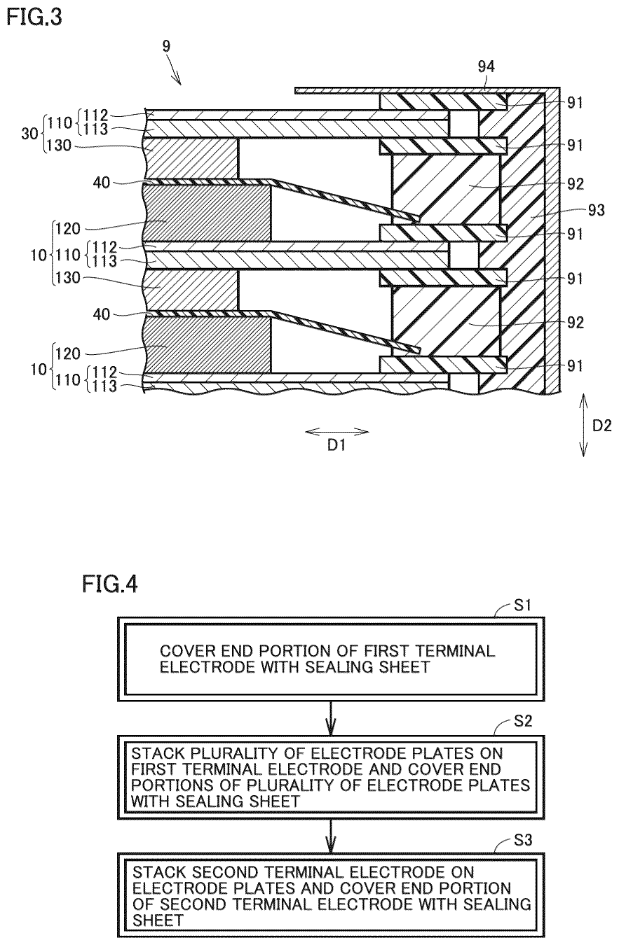

FIG. 3 is a cross-sectional view showing a part of the power storage module according to the comparative example. As shown in FIG. 3, a power storage module 9 according to the comparative example does not include the sealing sheet in the first embodiment. Power storage module 9 according to the comparative example further includes a plurality of first seal members 91, a plurality of spacers 92, a second seal member 93, and an exterior package 94.

The plurality of first seal members 91 are disposed on both sides of end portions 11 of the plurality of electrode plates 10 (current collector foils 110) in second direction D2. Each of the plurality of spacers 92 is disposed between a pair of first seal members 91 disposed between current collector foils 110 adjacent to each other in second direction D2. In power storage module 9 according to the comparative example, an internal space defined by the plurality of electrode plates 10 adjacent to each other and the plurality of first seal members 91 and spacer 92 is formed. In other words, the plurality of first seal members 91 and spacer 92 seal a space between electrode plates 10. In addition, since spacer 92 has a prescribed thickness, a space for injecting an electrolyte solution into the above-described internal space is ensured. Furthermore, mutual contact between first current collector 112 of current collector foil 110 and second current collector 113 of another current collector foil 110 adjacent thereto is suppressed by the plurality of first seal members 91 and spacer 92. In a stacked monopolar battery different from the comparative example, a plurality of positive electrode foils may have the same potential and a plurality of negative electrode foils may have the same potential. However, in power storage module 9 that is a bipolar battery, the plurality of current collector foils 110 always have different potentials. Therefore, the occurrence of a short circuit caused by contact between the plurality of current collector foils 110 is suppressed by the plurality of first seal members 91 and spacer 92. A part of the plurality of first seal members 91 and the plurality of spacers 92 are buried in second seal member 93. Thus, leakage of the electrolyte solution in the above-described internal space to the outside of power storage module 9 can be further suppressed. Exterior package 94 covers the outer side of second seal member 93.

In power storage module 9 according to the comparative example, the plurality of first seal members 91, the plurality of spacers 92 and second seal member 93 are formed by different members as described above. It is difficult in manufacturing to form all of these three types of members as an integral molded component. It is also difficult in manufacturing to form a pair of first seal members 91 and spacer 92 as an integral molded component, and even if such a molded component can be formed, it is difficult in manufacturing to insert and dispose the molded component between current collector foils 110. In addition, if the pair of first seal members 91 and spacer 92 are formed as an integral molded component, the manufacturing cost may rise.

However, as described above, in power storage module 1 according to the first embodiment of the present disclosure, sealing sheet 50 covers end portions 11 of current collector foils 110 of the plurality of electrode plates 10 in first direction D1. Sealing sheet 50 includes the plurality of side wall portions 51, the plurality of folded portions 52, and folded-back portion 53. The plurality of side wall portions 51 are disposed on the outer sides of current collector foils 110 of the plurality of electrode plates 10 in first direction D1, respectively. The plurality of folded portions 52 are folded from the plurality of side wall portions 51 toward the spaces between the plurality of electrode plates 10, respectively. Folded-back portion 53 connects corresponding two of the plurality of folded portions 52 adjacent to each other between corresponding two of the plurality of electrode plates 10. Each of the plurality of folded portions 52 is at least partially welded to current collector foil 110 of a corresponding one of the plurality of electrode plates 10.

Thus, sealing sheet 50 can seal the spaces between the plurality of electrode plates 10 and can function as an exterior member for the plurality of electrode plates 10. Therefore, the number of components in power storage module 1 can be reduced. In addition, a volume ratio of the plurality of electrode plates 10 in power storage module 1 can be increased and the energy density of power storage module 1 can be enhanced. Although power storage module 1 is described as an example of a bipolar battery in the present embodiment, power storage module 1 can achieve the same effect even when power storage module 1 is a monopolar battery, because power storage module 1 has the above-described configuration.

In addition, in the present embodiment, sealing sheet 50 includes resin layer 501 and metal layer 502. Metal layer 502 is provided on the surface of resin layer 501 opposite to the surface of resin layer 501 facing the plurality of electrode plates 10. Thus, water permeation in power storage module 1 can be suppressed without further providing another member different from sealing sheet 50.

In some embodiments, the metal layer 502 of sealing sheet 50 is an outermost layer. Thus, water permeation through sealing sheet 50 can be suppressed and the thickness of sealing sheet 50 can be made relatively thin. By making the thickness of sealing sheet 50 relatively thin, space-saving power storage module 1 can be achieved.

Furthermore, in the present embodiment, resin layer 501 includes a polypropylene resin or a polyethylene resin. Thus, a water absorption rate of resin layer 501 can be lowered.

In addition, in the present embodiment, each of the plurality of electrode plates 10 includes first active material layer 120 formed on current collector foil 110, and second active material layer 130 formed on current collector foil 110. First active material layer 120 is located on one side of current collector foil 110 in second direction D2. Second active material layer 130 is located on the other side of current collector foil 110 in second direction D2. One of first active material layer 120 and second active material layer 130 is a negative electrode active material layer, and the other is a positive electrode active material layer. Each of the plurality of separators 40 is disposed between first active material layer 120 and second active material layer 130 adjacent to each other.

According to the above-described configuration, each of the plurality of electrode plates 10 serves as a bipolar electrode, and power storage module 1 serves as a bipolar battery. In power storage module 1 serving as a bipolar battery, the plurality of current collector foils 110 have different potentials. In order to suppress the occurrence of a short circuit, it is important to suppress mutual contact between the plurality of current collector foils 110. In order to suppress contact between current collector foils 110, the plurality of first seal members 91 and the plurality of spacers 92, second seal member 93 that fixes these components, and exterior package 94 that covers second seal member 93 are provided in the comparative example. However, according to the above-described configuration in the present embodiment, one sealing sheet 50 forms the plurality of folded portions 52 and folded-back portion 53, which results in suppression of contact between current collector foils 110. Furthermore, as described above, sealing sheet 50 can also function as an exterior member. Therefore, when power storage module 1 according to the present embodiment is a bipolar battery, the number of components can be made extremely smaller than that in a bipolar battery as in the comparative example.

Next, a method for manufacturing power storage module 1 according to the first embodiment of the present disclosure will be described. FIG. 4 is a flowchart showing the method for manufacturing the power storage module according to the first embodiment of the present disclosure. As shown in FIGS. 1 to 4, the method for manufacturing the power storage module according to the first embodiment of the present disclosure includes, in the below-described order, step S1 of covering end portion 21 of first terminal electrode 20 with sealing sheet 50, step S2 of stacking the plurality of electrode plates 10 on first terminal electrode 20 and covering end portions 11 of the plurality of electrode plates 10 (current collector foils 110 thereof) with sealing sheet 50, and step S3 of stacking second terminal electrode 30 on electrode plates 10 and covering end portion 31 of second terminal electrode 30 with sealing sheet 50.

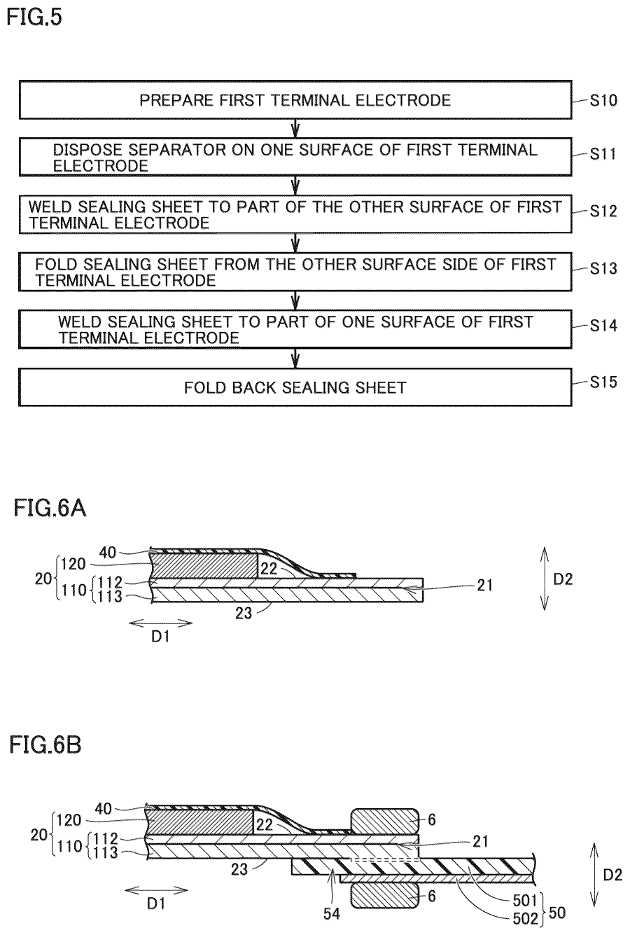

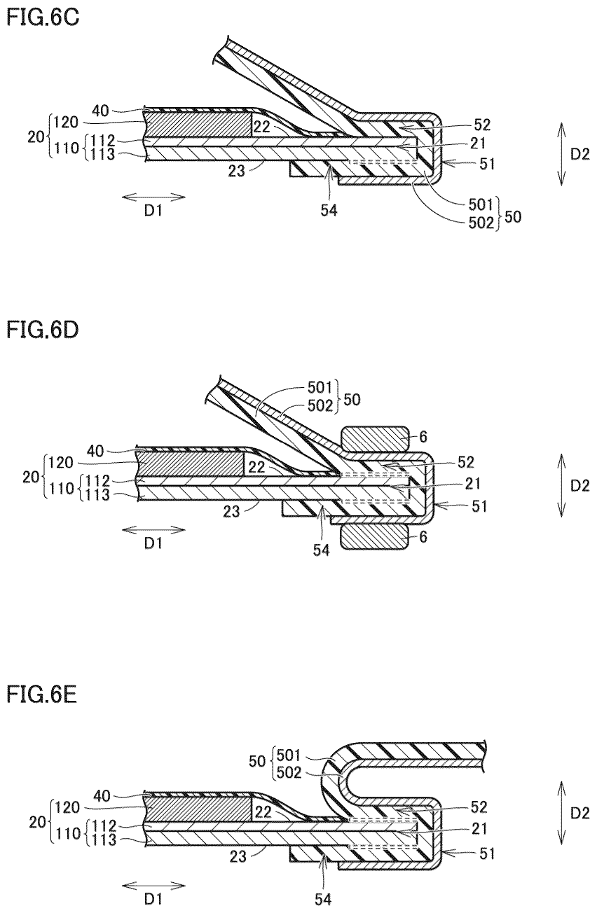

First, step S1 will be described. FIG. 5 is a flowchart showing step S1 of the method for manufacturing the power storage module. FIGS. 6A to 6E are schematic cross-sectional views each schematically showing a flow of step S1.

As shown in FIGS. 5 and 6A, in step S1, first terminal electrode 20 is first prepared (step S10). Then, separator 40 is disposed on one surface (first surface 22) of first terminal electrode 20 (step S11).

Next, as shown in FIGS. 5, 6A and 6B, sealing sheet 50 is welded to a part of the other surface (second surface 23) of first terminal electrode 20 (step S12). Specifically, first edge portion 54 of sealing sheet 50 is welded to second surface 23 of end portion 21 of first terminal electrode 20. End portion 21 of first terminal electrode 20 and first edge portion 54 of sealing sheet 50 are sandwiched and heated from both sides in second direction D2 by a pair of heaters 6. As a result, a surface of resin layer 501 of first edge portion 54 melts and is thermally welded to first terminal electrode 20.

Next, as shown in FIGS. 5, 6B and 6C, sealing sheet 50 is folded from the other surface (second surface 23) side of first terminal electrode 20 such that sealing sheet 50 covers end portion 21 of first terminal electrode 20 and a part of the one surface (first surface 22) of first terminal electrode 20 (step S13). As a result, side wall portion 51 is formed on the outer side of first terminal electrode 20 in first direction D1. Furthermore, folded portion 52 is formed on the first surface 22 side of first terminal electrode 20.

Next, as shown in FIGS. 5, 6C and 6D, sealing sheet 50 is welded to a part of the one surface (first surface 22) of first terminal electrode 20 (step S14). Specifically, folded sealing sheet 50 (folded portion 52) is welded to first surface 22 of end portion 21 of first terminal electrode 20. Together with first edge portion 54, end portion 21 of first terminal electrode 20 and folded portion 52 are sandwiched and heated from both sides in second direction D2 by the pair of heaters 6. As a result, a surface of resin layer 501 of folded portion 52 melts and is thermally welded to first terminal electrode 20.

At the end of step S1, as shown in FIGS. 5, 6D and 6E, sealing sheet 50 is folded back on the one surface (first surface 22) side of first terminal electrode 20 (step S15). As a result, sealing sheet 50 extends toward the outer side of first terminal electrode 20 in first direction D1. Specifically, the vicinity of the inner side of the portion of folded sealing sheet 50 welded to first surface 22 of first terminal electrode 20 is folded back.

As described above, in the present embodiment, step S1 includes steps S10 to S15 in this order. However, the order of steps S10 to S15 is not limited to the above-described order.

Next, step S2 will be described. In step S2, a series of steps are repeated. Therefore, a part of the steps included in step S2 will be described below.

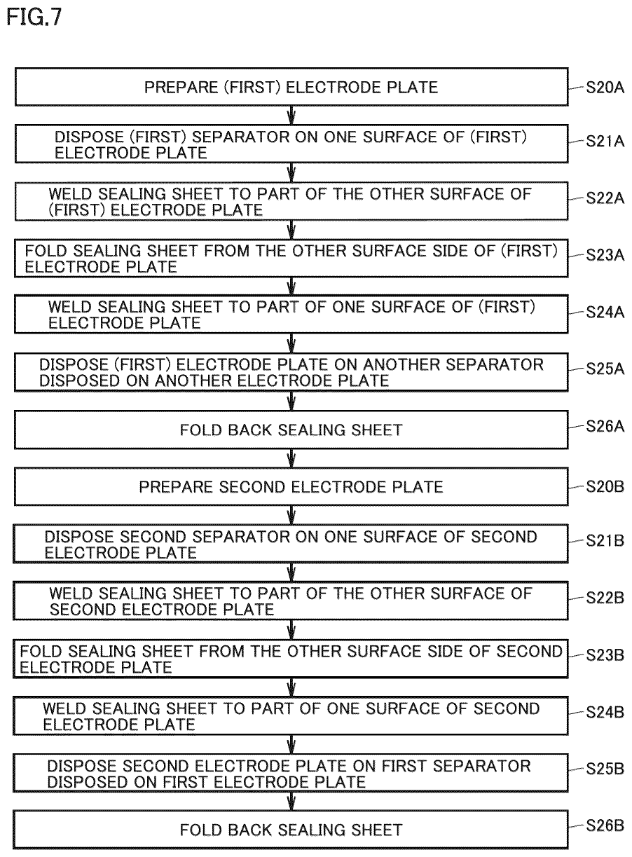

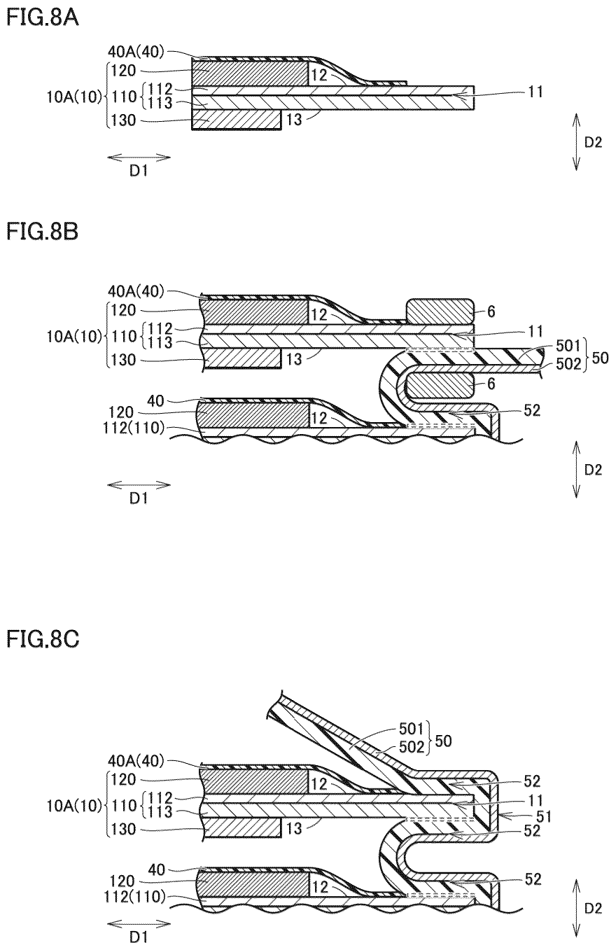

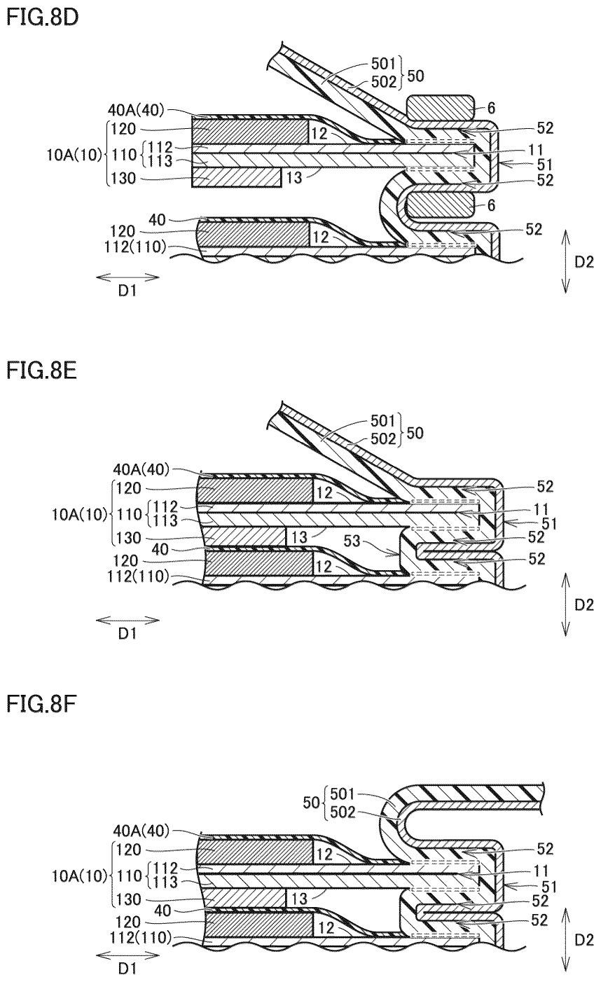

FIG. 7 is a flowchart showing a part of step S2 of the method for manufacturing the power storage module. FIGS. 8A to 8F are schematic cross-sectional views each schematically showing a part of a flow of step S2.

The step of covering end portion 11 of a first electrode plate 10A (current collector foil 110 thereof) serving as electrode plate 10 with sealing sheet 50 will be described. As shown in FIGS. 7 and 8A, first electrode plate 10A is first prepared (step S20A). Then, a first separator 40A is disposed on one surface (first surface 12) of first electrode plate 10A (step S21A).

Next, as shown in FIGS. 7, 8A and 8B, folded-back sealing sheet 50 is welded to a part of the other surface (second surface 13) of first electrode plate 10A (step S22A). Specifically, a part of folded-back sealing sheet 50 is welded to second surface 13 of end portion 11 of first electrode plate 10A (current collector foil 110 thereof). End portion 11 of first electrode plate 10A (current collector foil 110 thereof) and the part of folded-back sealing sheet 50 are sandwiched and heated from both sides in second direction D2 by the pair of heaters 6. As a result, a surface of resin layer 501 of folded-back sealing sheet 50 melts and is thermally welded to first electrode plate 10A.

Folded-back sealing sheet 50 described above is sealing sheet 50 having folded portion 52 welded to first surface 12 of another electrode plate 10 different from first electrode plate 10A. When first electrode plate 10A is electrode plate 10 adjacent to first terminal electrode 20, folded-back sealing sheet 50 described above may be sealing sheet 50 having folded portion 52 welded to first surface 22 of first terminal electrode 20.

Next, as shown in FIGS. 7, 8B and 8C, sealing sheet 50 is folded from the other surface (second surface 13) side of first electrode plate 10A such that sealing sheet 50 covers end portion 11 of first electrode plate 10A (current collector foil 110 thereof) and a part of the one surface (first surface 12) of first electrode plate 10A (step S23A). As a result, folded portion 52 is formed on the second surface 13 side of first electrode plate 10A. Furthermore, side wall portion 51 is formed on the outer side of first electrode plate 10A in first direction D1. Folded portion 52 is also formed on the first surface 12 side of first electrode plate 10A.

Next, as shown in FIGS. 7, 8C and 8D, sealing sheet 50 is welded to a part of the one surface (first surface 12) of first electrode plate 10A (step S24A). Specifically, folded sealing sheet 50 (folded portion 52) is welded to first surface 12 of end portion 11 of first electrode plate 10A (current collector foil 110 thereof). Together with folded portion 52 on second surface 13, end portion 11 of first electrode plate 10A (current collector foil 110 thereof) and folded portion 52 on first surface 12 are sandwiched and heated from both sides in second direction D2 by the pair of heaters 6. As a result, a surface of resin layer 501 of folded portion 52 on first surface 12 melts and is thermally welded to first electrode plate 10A.

Next, as shown in FIGS. 7, 8D and 8E, first electrode plate 10A is disposed on separator 40 of another electrode plate 10 (step S25A). Specifically, second active material layer 130 of first electrode plate 10A is disposed on another separator 40 of another electrode plate 10. Along with this, folded portion 52 disposed on second surface 13 of first electrode plate 10A is disposed on folded portion 52 disposed on first surface 12 of another electrode plate 10. As a result, folded-back portion 53 that connects these folded portions 52 to each other is formed between first electrode plate 10A and another electrode plate 10. Also when first electrode plate 10A is electrode plate 10 adjacent to first terminal electrode 20, folded-back portion 53 is formed between first electrode plate 10A and first terminal electrode 20 similarly to the above.

Next, as shown in FIGS. 7, 8E and 8F, sealing sheet 50 is folded back on the one surface (first surface 12) side of first electrode plate 10A (step S26A). As a result, sealing sheet 50 extends toward the outer side of first electrode plate 10A in first direction D1. Specifically, the vicinity of the inner side of the portion of folded sealing sheet 50 welded to first surface 12 of first electrode plate 10A is folded back.

As described above, in the present embodiment, step S2 includes steps S20A to S26A in this order. In steps S20A to S26A, first electrode plate 10A is stacked on another electrode plate 10 with separator 40 being interposed and end portion 11 of first electrode plate 10A (current collector foil 110 thereof) is covered with the sealing sheet. However, the order of steps S20A to S26A is not limited to the above-described order.

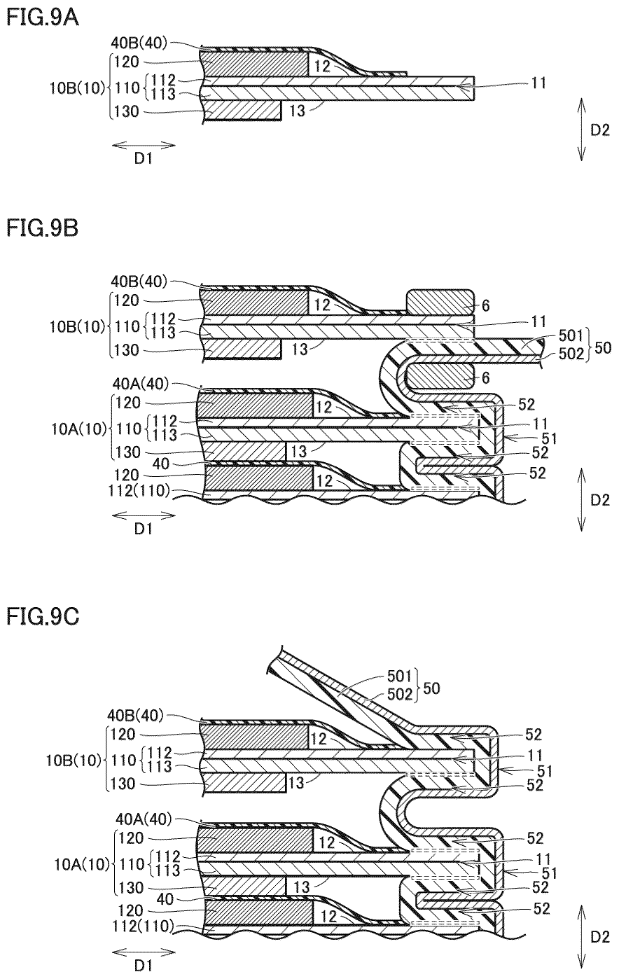

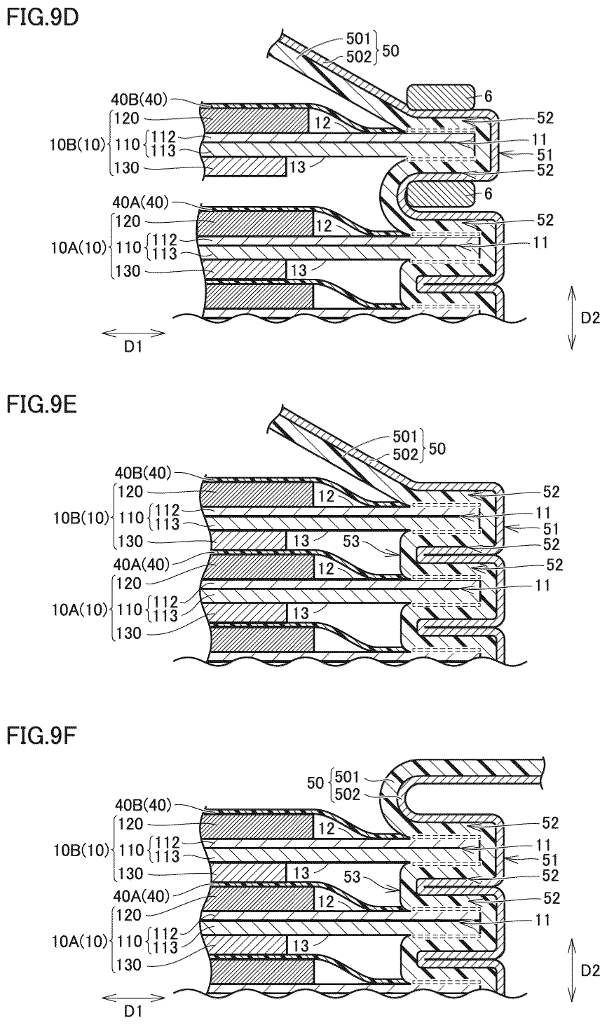

In step S2, above-described steps S20A to S26A are repeated as many times as the number of electrode plates 10. FIGS. 9A to 9F are schematic cross-sectional views each schematically showing a continuation of the part of the flow of step S2 shown in each of FIGS. 8A to 8F. For example, as shown in FIGS. 7 and 9A to 9F, in steps S20B to S26B, second electrode plate 10B is stacked on first electrode plate 10A with first separator 40A being interposed and end portion 11 of second electrode plate 10B (current collector foil 110 thereof) is covered with sealing sheet 50. Steps S20B to S26B can be performed by replacing another electrode plate 10 and first electrode plate 10A and another separator 40 and first separator 40A in steps S20A to S26A with first electrode plate 10A and second electrode plate 10B and first separator 40A and second separator 40B, respectively.

As described above, as shown in FIGS. 7, 8A to 8F and 9A to 9F, the method for manufacturing power storage module 1 according to the embodiment of the present disclosure includes: disposing first separator 40A on at least one active material layer located on the one surface (first surface 12) side of first electrode plate 10A, first electrode plate 10A including current collector foil 110 and the at least one active material layer formed on the current collector foil (step S21A); folding sealing sheet 50 from the other surface (second surface 13) side of current collector foil 110 of first electrode plate 10A such that sealing sheet 50 covers end portion 11 of current collector foil 110 of first electrode plate 10A and a part of the one surface (first surface 12) of current collector foil 110 of first electrode plate 10A (step S23A); welding sealing sheet 50 to the part of the one surface (first surface 12) of current collector foil 110 of first electrode plate 10A (step S24A); folding back sealing sheet 50 on the one surface (first surface 12) side of current collector foil 110 of first electrode plate 10A (step S26A); welding folded-back sealing sheet 50 to a part of the other surface (second surface 13) of current collector foil 110 of second electrode plate 10B opposite to one surface (first surface 12) of current collector foil 110 of second electrode plate 10B, second electrode plate 10B including current collector foil 110 and at least one active material layer formed on the current collector foil (step S22B); folding sealing sheet 50 from the other surface (second surface 13) side of current collector foil 110 of second electrode plate 10B such that folded-back sealing sheet 50 covers end portion 11 of current collector foil 110 of second electrode plate 10B and a part of the one surface (first surface 12) of current collector foil 110 of second electrode plate 10B (step S23B); and disposing the active material layer of second electrode plate 10B on first separator 40A (step S25B).

Thus, sealing sheet 50 can seal the space between current collector foil 110 of first electrode plate 10A and current collector foil 110 of second electrode plate 10B, and can function as an exterior member for first electrode plate 10A and second electrode plate 10B. Therefore, the number of components in power storage module 1 can be reduced, which can lead to a simple structure of power storage module 1. Furthermore, according to the above-described configuration, relatively thin sealing sheet 50 can seal the space between current collector foil 110 of first electrode plate 10A and current collector foil 110 of second electrode plate 10B. Therefore, a volume ratio of first electrode plate 10A and second electrode plate 10B in power storage module 1 can be increased and the energy density of power storage module 1 can be enhanced.

Disposing the active material layer of second electrode plate 10B on first separator 40A (step S25B) is performed after welding sealing sheet 50 to the part of the one surface (first surface 12) of current collector foil 110 of first electrode plate 10A (step S24A) and after welding folded-back sealing sheet 50 to the part of the other surface (second surface 13) of current collector foil 110 of second electrode plate 10B (step S22B).

Thus, sealing sheet 50 can be welded during the process of stacking first electrode plate 10A, separator 40 and second electrode plate 10B. This can result in reduction of the number of the steps for manufacturing power storage module 1.

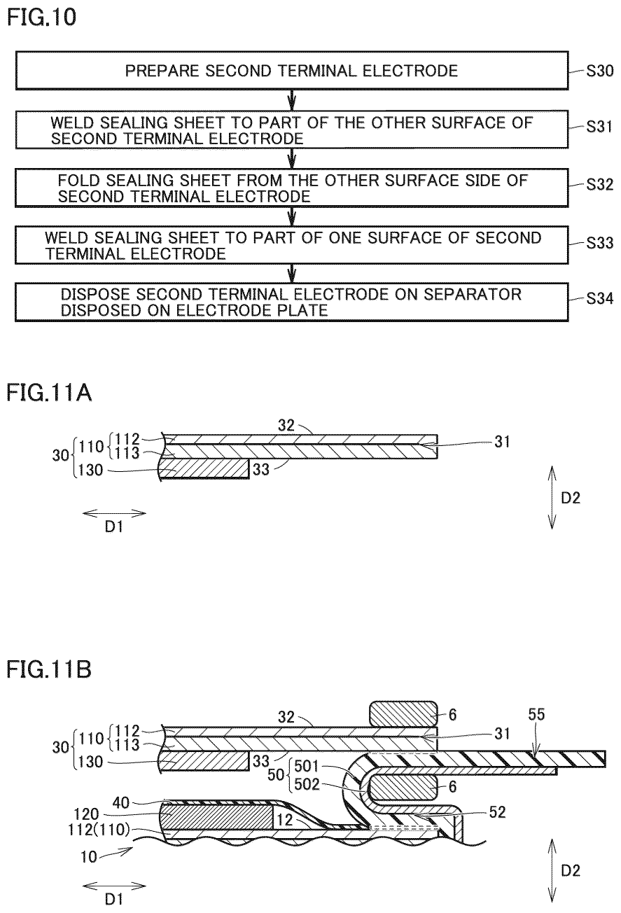

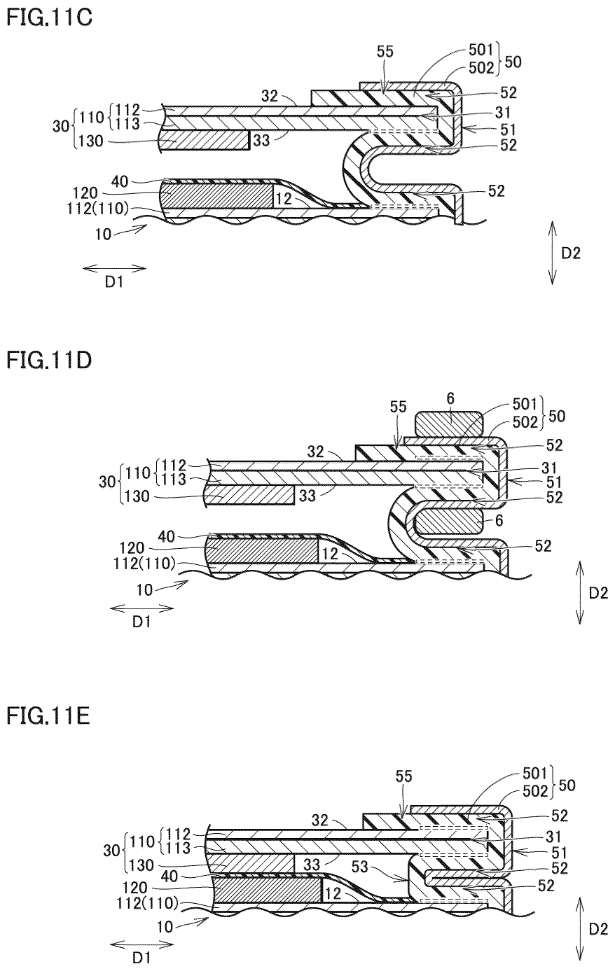

Finally, step S3 will be described. FIG. 10 is a flowchart showing step S3 of the method for manufacturing the power storage module. FIGS. 11A to 11E are schematic cross-sectional views each schematically showing a flow of step S3.

As shown in FIGS. 10 and 11A, second terminal electrode 30 is first prepared (step S30). Next, as shown in FIGS. 10, 11A and 11B, folded-back sealing sheet 50 is welded to a part of the other surface (second surface 33) of second terminal electrode 30 (step S31). Specifically, a part of folded-back sealing sheet 50 is welded to second surface 33 of end portion 31 of second terminal electrode 30. End portion 31 of second terminal electrode 30 and the part of folded-back sealing sheet 50 are sandwiched and heated from both sides in second direction D2 by the pair of heaters 6. As a result, a surface of resin layer 501 of folded-back sealing sheet 50 melts and is thermally welded to second terminal electrode 30. Folded-back sealing sheet 50 described above is sealing sheet 50 having folded portion 52 formed by welding sealing sheet 50 to first surface 12 of electrode plate 10 adjacent to second terminal electrode 30.

Next, as shown in FIGS. 10, 11B and 11C, sealing sheet 50 is folded from the other surface (second surface 33) side of second terminal electrode 30 such that sealing sheet 50 covers end portion 31 of second terminal electrode 30 and a part of one surface (first surface 32) of second terminal electrode 30 (step S32). As a result, folded portion 52 is formed on the second surface 13 side of second terminal electrode 30. Furthermore, side wall portion 51 is formed on the outer side of second terminal electrode 30 in first direction D1. Moreover, second edge portion 55 of sealing sheet 50 is disposed on the first surface 32 side of second terminal electrode 30.

Next, as shown in FIGS. 10, 11C and 11D, sealing sheet 50 is welded to a part of the one surface (first surface 32) of second terminal electrode 30 (step S33). Specifically, second edge portion 55 of sealing sheet 50 is welded to first surface 32 of end portion 31 of second terminal electrode 30. Together with folded portion 52 on second surface 33, end portion 31 of second terminal electrode 30 and second edge portion 55 on first surface 32 are sandwiched and heated from both sides in second direction D2 by the pair of heaters 6. As a result, a surface of resin layer 501 of second edge portion 55 on first surface 32 melts and is thermally welded to second terminal electrode 30.

Finally, as shown in FIGS. 10, 11D and 11E, second terminal electrode 30 is disposed on separator 40 of electrode plate 10 (step S34). Specifically, second active material layer 130 of second terminal electrode 30 is disposed on separator 40 of electrode plate 10 adjacent to second terminal electrode 30. Along with this, folded portion 52 disposed on second surface 33 of second terminal electrode 30 is disposed on folded portion 52 disposed on first surface 12 of electrode plate 10 adjacent to second terminal electrode 30. As a result, folded-back portion 53 that connects these folded portions 52 to each other is formed between second terminal electrode 30 and electrode plate 10.

As described above, in the present embodiment, step S3 includes steps S30 to S34 in this order. However, the order of steps S30 to S34 is not limited to the above-described order.

The power storage module according to the first embodiment of the present disclosure can be manufactured through steps S1, S2 and S3 described above.

### Second Embodiment

Next, a power storage module according to a second embodiment of the present disclosure will be described. The power storage module according to the second embodiment is different from the power storage module according to the first embodiment in terms of the configuration of the plurality of folded-back portions. Description of the same configuration and effect as those of the power storage module according to the first embodiment will not be repeated.

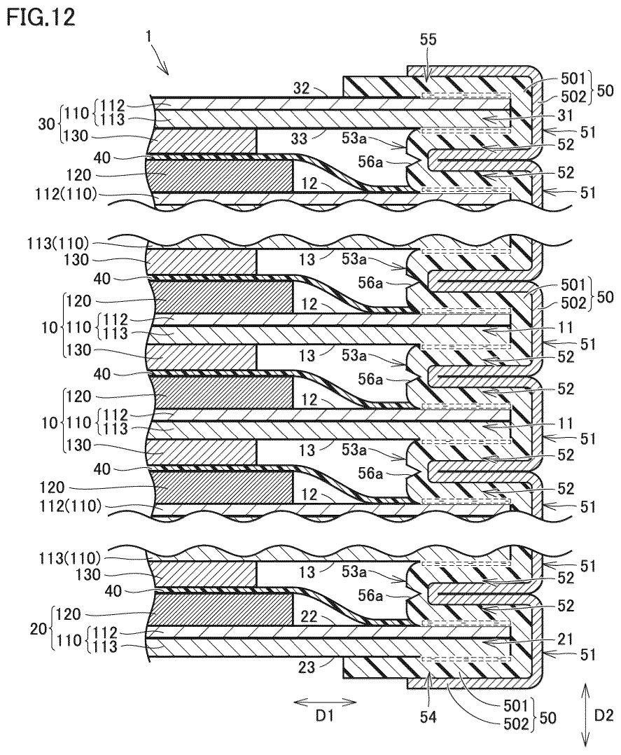

FIG. 12 is a cross-sectional view showing a part of the power storage module according to the second embodiment of the present disclosure. FIG. 12 shows the power storage module in a cross-sectional view similar to that in FIG. 2 in the first embodiment.

As shown in FIG. 12, in a power storage module 1a according to the second embodiment of the present disclosure, a groove portion 56a is formed in resin layer 501 of at least one folded-back portion 53a. Thus, the stress in folded-back portion 53 of sealing sheet 50 can be relieved.

Groove portion 56a may be formed in any folded-back portion 53a. One or more groove portions 56a may be formed in one or more folded-back portions 53a located between electrode plates 10, respectively. Groove portion 56a may be formed in folded-back portion 53a located between first terminal electrode 20 and electrode plate 10 adjacent thereto. Groove portion 56a may be formed in folded-back portion 53a located between second terminal electrode 30 and electrode plate 10 adjacent thereto. In the present embodiment, groove portions 56a are formed in all of folded-back portions 53a.

Groove portion 56a may extend in a direction orthogonal to the sheet plane in FIG. 12 (i.e., a direction orthogonal to first direction D1 and second direction D2). Groove portion 56a is formed in resin layer 501. Metal layer 502 may be exposed in groove portion 56a. Resin layer 501 may be divided into a plurality of portions by groove portion 56a.

### Third Embodiment

Next, a power storage module according to a third embodiment of the present disclosure will be described. The power storage module according to the third embodiment is different from the power storage module according to the first embodiment in terms of the configuration of the sealing sheet. Description of the same configuration and effect as those of the power storage module according to the first embodiment will not be repeated.

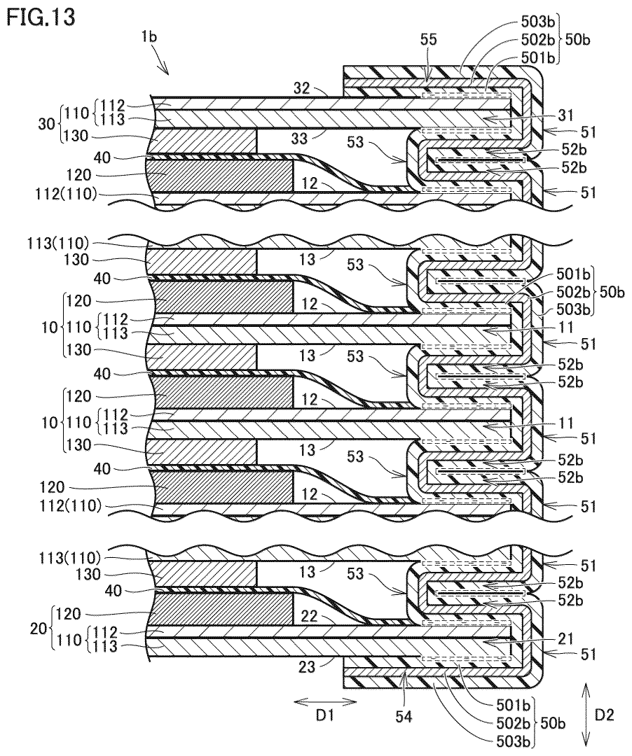

FIG. 13 is a cross-sectional view showing a part of the power storage module according to the third embodiment of the present disclosure. FIG. 13 shows the power storage module in a cross-sectional view similar to that in FIG. 2 in the first embodiment.

As shown in FIG. 13, in a power storage module 1b according to the third embodiment of the present disclosure, a sealing sheet 50b further includes an outer resin layer 503b. Outer resin layer 503b is provided on a surface of a metal layer 502b opposite to a surface of metal layer 502b that is in contact with a resin layer 501b. Thus, the outer side of metal layer 502b can be easily insulated.

Outer resin layers 503b of corresponding two of a plurality of folded portions 52b (a pair of folded portions 52b) are at least partially welded to each other between corresponding two of the plurality of electrode plates 10. Thus, the shape of sealing sheet 50b can be maintained more firmly.

In a method for manufacturing power storage module 1b according to the present embodiment, each of end portions 21, 11 and 31 are covered with sealing sheet 50b, and then, a plurality of the pairs of folded portions 52b are heated, similarly to steps S1 to S3 in the method for manufacturing the power storage module according to the first embodiment. As a result, outer resin layers 503b of each pair of folded portions 52b are thermally welded to each other. At this time, the pair of folded portions 52b can be heated from the side opposite to the folded-back portion 53 side.

In the description of the above-described embodiments, the features that can be combined may be combined mutually.

Although the embodiments of the present disclosure have been described, it should be understood that the embodiments disclosed herein are illustrative and non-restrictive in every respect. The scope of the present disclosure is defined by the terms of the claims, and is intended to include any modifications within the scope and meaning equivalent to the terms of the claims.

What is claimed is:

1. A power storage module comprising:
a plurality of electrode plates;
a plurality of separators; and
a sealing sheet, wherein
each of the plurality of electrode plates includes a current collector foil and at least one active material layer formed on the current collector foil,
a plane direction of each of the plurality of electrode plates extends along a first direction,
the plurality of electrode plates are arranged side by side in a second direction orthogonal to the first direction,
each of the plurality of separators is disposed between the active material layers of corresponding two of the plurality of electrode plates adjacent to each other,
the sealing sheet covers end portions of the current collector foils of the plurality of electrode plates in the first direction,
the sealing sheet includes:
a plurality of side wall portions disposed on outer sides of the current collector foils of the plurality of electrode plates in the first direction, respectively;
a plurality of folded portions folded from the plurality of side wall portions toward spaces between the plurality of electrode plates, respectively; and
a folded-back portion that connects corresponding two of the plurality of folded portions adjacent to each other between corresponding two of the plurality of electrode plates, and
each of the plurality of folded portions is at least partially welded to the current collector foil of a corresponding one of the plurality of electrode plates.

2. The power storage module according to claim 1, wherein
the sealing sheet includes a resin layer and a metal layer provided on a surface of the resin layer opposite to a surface of the resin layer facing the plurality of electrode plates.

3. The power storage module according to claim 2, wherein
the resin layer includes a polypropylene resin or a polyethylene resin.

4. The power storage module according to claim 2, wherein
a groove portion is formed in the resin layer of the folded-back portion.

5. The power storage module according to claim 2, wherein
the sealing sheet further includes an outer resin layer provided on a surface of the metal layer opposite to a surface of the metal layer that is in contact with the resin layer.

6. The power storage module according to claim 5, wherein
the outer resin layers of corresponding two of the plurality of folded portions are at least partially welded to each other between corresponding two of the plurality of electrode plates.

7. The power storage module according to claim 1, wherein
each of the plurality of electrode plates includes a first active material layer formed on the current collector foil, and a second active material layer formed on the current collector foil,
the first active material layer is located on one side of the current collector foil in the second direction,
the second active material layer is located on the other side of the current collector foil in the second direction,
one of the first active material layer and the second active material layer is a negative electrode active material layer, and the other is a positive electrode active material layer, and
each of the plurality of separators is disposed between the first active material layer and the second active material layer adjacent to each other.

8. The power storage module according to claim 1, wherein
the power storage module is a power storage module implemented by a bipolar-type battery.

9. A method for manufacturing a power storage module, the method comprising:
disposing a separator on at least one active material layer located on one surface side of a first electrode plate, the first electrode plate including a current collector foil and the at least one active material layer formed on the current collector foil;
folding a sealing sheet from the other surface side of the current collector foil of the first electrode plate such that the sealing sheet covers an end portion of the current collector foil of the first electrode plate and a part of the one surface of the current collector foil of the first electrode plate;
welding the sealing sheet to the part of the one surface of the current collector foil of the first electrode plate;
folding back the sealing sheet on the one surface side of the current collector foil of the first electrode plate;
welding the folded-back sealing sheet to a part of the other surface of a current collector foil of a second electrode plate opposite to one surface of the current collector foil of the second electrode plate, the second electrode plate including the current collector foil and at least one active material layer formed on the current collector foil;
folding the sealing sheet from the other surface side of the current collector foil of the second electrode plate such that the folded-back sealing sheet covers an end portion of the current collector foil of the second electrode plate and a part of the one surface of the current collector foil of the second electrode plate; and
disposing the active material layer of the second electrode plate on the separator.

10. The method for manufacturing the power storage module according to claim 9, wherein
disposing the active material layer of the second electrode plate on the separator is performed after welding the sealing sheet to the part of the one surface of the current collector foil of the first electrode plate and after welding the folded-back sealing sheet to the part of the other surface of the current collector foil of the second electrode plate.

11. The power storage module according to claim 3, wherein
a groove portion is formed in the resin layer of the folded-back portion.

12. The power storage module according to claim 3, wherein
the sealing sheet further includes an outer resin layer provided on a surface of the metal layer opposite to a surface of the metal layer that is in contact with the resin layer.

13. The power storage module according to claim 12, wherein
the outer resin layers of corresponding two of the plurality of folded portions are at least partially welded to each other between corresponding two of the plurality of electrode plates.
